(19) United States
(12) Patent Application Publication
(10) Pub. No.: US 2009/0259711 A1
(43) Pub. Date: Oct. 15, 2009

(54) Synchronization of Media State Across Multiple Devices

(75) Inventors: Gilles Drieu, San Francisco, CA (US); Barry Richard Munsterteiger, Belmont, CA (US)

Correspondence Address: FISH & RICHARDSON P.C., PO BOX 1022, MINNEAPOLIS, MN, 55440-1022, US

(73) Assignee: APPLE INC., Cupertino, CA (US)

(21) Appl. No.: 12/101,896

(22) Filed: Apr. 11, 2008

(51) Int. Cl. G06F 15/16

(52) U.S. Cl. 709/201

(57) ABSTRACT

Media state synchronization across multiple devices can include detecting an event relating to a user's access of content on a first device, determining state information relating to an access state of the content corresponding to the detected event, and transmitting the determined state information to a remote location for use in accessing the content on a second device.

### TECHNICAL FIELD

The present disclosure relates to synchronizing media state across multiple devices.

### BACKGROUND

Content can include media objects, such as movies, audio files, digital video, presentations, and documents. The media objects can be stored on and accessed over networks. Devices such as a laptop, mobile phone, computer, entertainment system., and a mobile media device can be used to access the content. A user can switch devices while viewing a media object. For example, a user might view part of a movie on a laptop and a second part of the movie on a mobile phone. Typically, a user has to reposition the playback of the media object to the position where the user was last when switching between devices.

### SUMMARY

This specification describes technologies that, among other things, synchronize media state across multiple devices.

In general, the subject matter described can be implemented in methods that include detecting an event relating to a user's access of content on a first device, determining state information relating to an access state of the content corresponding to the detected event, and transmitting the determined state information to a remote location for use in accessing the content on a second device. Other implementations can include corresponding systems, apparatus, and computer program products.

These, and other aspects, can include one or more of the following features. The detected event c(an include at least one of pause, stop, access complete, power off, and user input. The state information can include a playhead position. The state information can include an indication of whether the content has been accessed completely. The content can include video, audio, text, graphics, or a combination thereof. Copies of the content can reside on each of the first and second devices. The content can reside at a remote location and can be streamed to a device during access. The remote location can include a computer system accessible via a wide area network. The remote location can include a computer system within a same local area network as the first device. Content can include digital video and accessing the content can include playing a digital video file. The transmitted state information can be used to update content residing on the second device. The transmitted state information can be used to position an access point in the, content on the second device. The remote location can include a computer system within a same local area network as the second device. The first device can be located at the remote location. The second device can be located at the remote location. The content can include one or more media objects.

The subject matter described can also be implemented in methods that include receiving from a remote location state information relating to an access state of content on a first device and using the received state information to manage a user's access of content on a second device. Other implementations can include corresponding systems, apparatus, and computer program products.

These, and other aspects, can include one or more of the following features. The state information can include a playhead position. The state information can include an indication of whether the content has been accessed completely. The content can include video, audio, text, graphics, or a combination thereof. The content can include one or more media objects. The remote location can include a computer system within a same local area network as the second device. Content can include digital video and accessing the content can include playing a digital video file. The transmitted state information can be used to update content residing on the second device. The transmitted state information can be used to position an access point in the content on the second device. The remote location can include a computer system within a same local area network as the second device.

Particular implementations of the subject matter described in this specification may be implemented to realize one or more of the following potential advantages. The subject matter described can be implemented such that content access amongst devices can be synchronized. For example, a user viewing content on a first device can switch to a second device to continue viewing the content without having to manually reposition playback of the content on the second device to where the user left off on the first device. The subject matter described also can be implemented to retrieve content in anticipation of future content access.

The details of one or more implementations are set forth in the accompanying drawings and the description below. Other features and advantages will be apparent from the description and drawings, and from the claims.

### DESCRIPTION OF DRAWINGS

FIG. 1 shows an example of a distributed content viewing environment.

FIG. 2 shows another example of a distributed content viewing environment.

FIG. 3 shows an example of accessing content.

FIG. 4 shows an example of a content update event.

FIG. 5 shows an example of a content synchronization flowchart.

FIG. 6 shows an example of a flowchart of resuming playback based on an access state.

FIG. 7 shows an example of a synchronization process.

FIGS. 8A,B show examples of synchronization processes from a device view point.

Like reference symbols in the various drawings indicate like elements.

### DETAILED DESCRIPTION

Content can be, viewed on multiple devices. Viewing of content, such as a, digital video, can take place on two or more of these devices. In order for a user to continue to watch the digital video without having to reposition the playback of the digital video on another device, state information about the digital video can be distributed to the other device. The other device can use the state information to automatically reposition the playback of the digital video.

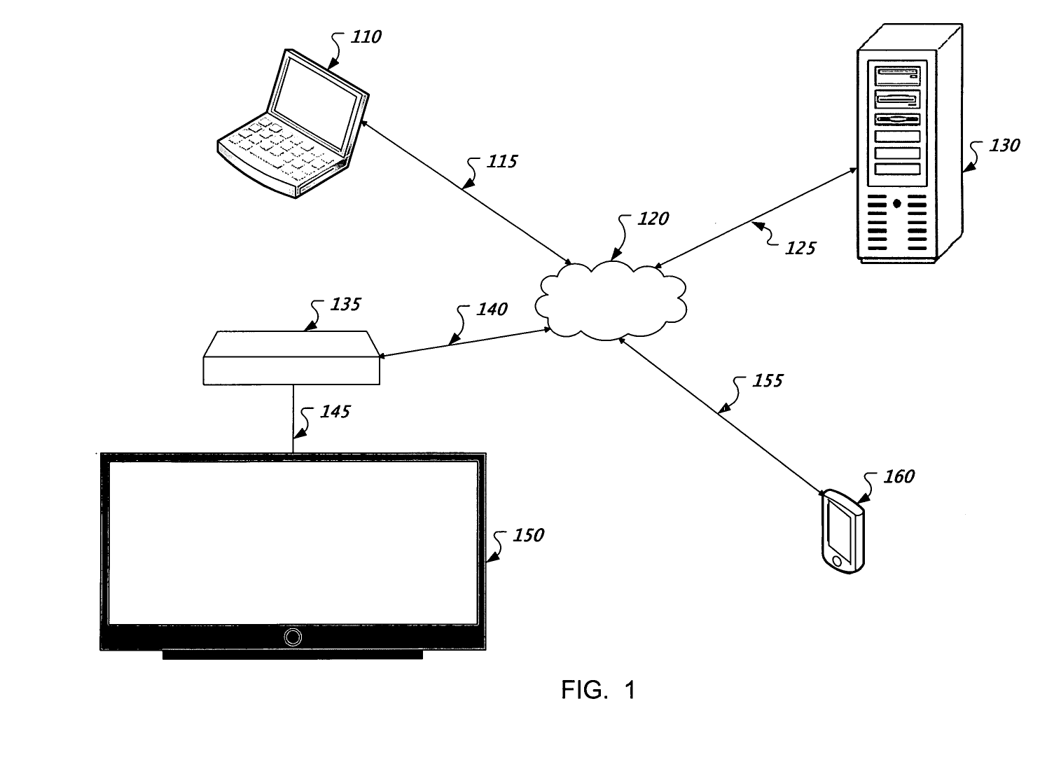

FIG. 1 shows an example of a distributed content viewing environment. Content can include one or more media objects. A media object can include digital video, audio, text, and/or graphics. For example, the media object can include a movie or presentation. The content can be viewed on multiple devices and combination of devices. For example, a mobile computing device 110, such as a laptop, can be used to view content and can be used to download content from a server 130. The mobile computing device 110 and server 130 can be connected to a communication network 120 via network connections 115, 125. The communication network 120 can include wired and wireless components. For example, the communication network 120 can include the Internet.

A media processing device 135, such as an AppleTV, manufactured by Apple Inc. of Cupertino, Calif., can download content from server 130 via network connection 140. A presentation device such as a monitor 150 can be coupled to the media processing device 135 through a media connector 145, such that video and/or audio information generated by the media processing device 135 can be presented through the monitor 150.

A mobile phone 160 can download content from server 130. For example, the mobile phone can be an iPhone, manufactured by Apple Inc. of Cupertino, Calif. The mobile phone 160 can connect to the network 120 via a wireless link 155 to download content from server 130.

A device, such as a mobile computing device 110, mobile phone 160, media processing device 135. etc., can be used to access content. The device can detect an event relating to an access of content. For example, the content can include a digital video such as a movie and one type of content access can include playing the movie. The access events for a movie can include when playback pauses, stops, rewinds, or fast forwards and when playback of the content is complete. In another example, the content can include a presentation and the content access can include advancing to a next slide within the presentation. The access events for a presentation can include advancing to the next slide or accessing a different slide within the presentation. In some implementations, access events can also include when a device starts to power down, user input, or a periodic firing of a timer.

The device can determine state information relating to an access state of the content corresponding to the detected event. In some implementations, state information relating to playback of content can include the position of a playhead. The playhead position can represent a currently or last displayed frame or slide. The determined state information can be sent to a remote location, such as a server 130, for use in accessing the content on a second device.

A user can create a play list that includes one or more media objects to access. For example, the play list can include multiple episodes of a television series. In another example, the play list can include one or more movies or audio files. A server such as server 130 can store the play list.

As an example, a user can watch a media object off of the play list such as a television episode on a mobile computing device 110. The user can begin playback of the episode on the mobile computing device 110. During playback, state information relating to the playback of the episode can be sent to server 130. A mobile phone 160 can obtain this state information then updates to this state information by requesting this information from server 130. In some implementations, the mobile phone 160 can download the episode being watched on the mobile computing device 110 in response to the state information. Additionally, the mobile phone 160 can download the next episode or media object in the play list. When playback continues on mobile phone 160, playback of the episode can continue at a position related to the position where playback was ceased on the mobile computing device 110. A similar transition of playback can happen between any pair of devices including media processing device 135 and mobile phone 160.

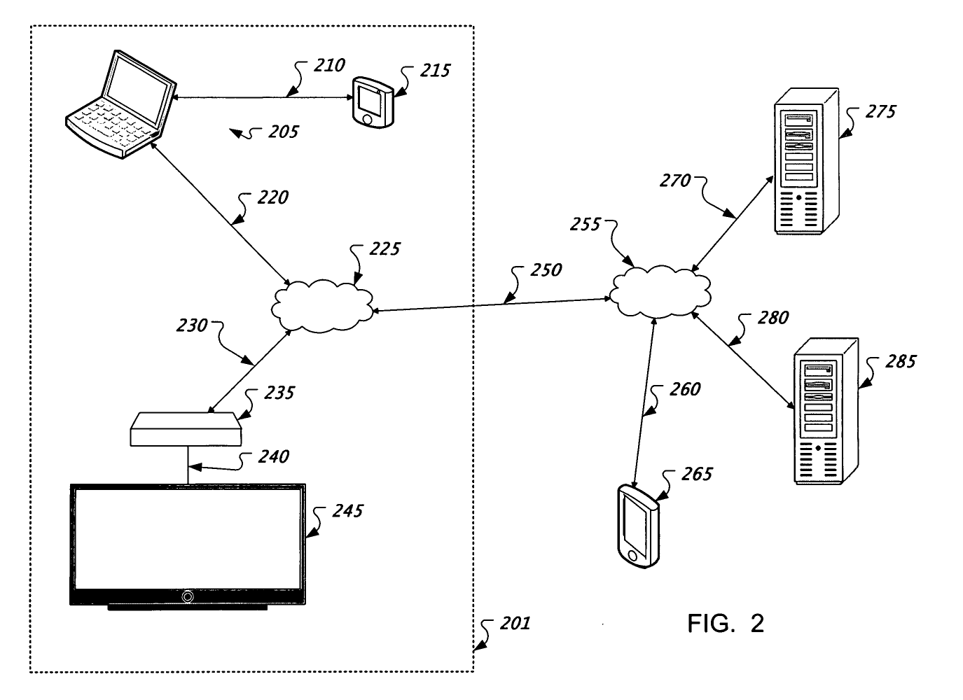

FIG. 2 shows another example of a distributed content viewing environment. The environment can include a host location 201, such as a home or office. The host location 201 can include a mobile computing device 205, mobile media player 215, and media processing device 235 connected via a media connector 240 to a presentation device such as a monitor 245 for viewing the output from the media processing device 235. The mobile computing device 205 and the media processing device 235 can be connected to a local area network (LAN) 225 via network connections 220, 230. Network connections 220, 230 can be wired or wireless. The LAN 225 can include wireless access points. LAN 225 can be connected to a wide area network (WAN) 255 via a network connection 250. A WAN 255 can include the Internet and wireless access points. A mobile phone 265 can connect to the WAN 255 via a wireless network connection 260.

A content storage server 275 and a content metadata server 285 can be connected to WAN 255 via network connections 270, 280. Content storage server 275 can store media objects such as movies, television episodes, music, or presentations. Devices such as mobile computing device 205, media processing device 235, and mobile phone 265 can download content from the content storage server 275. Additionally, mobile media player 215 can receive content from the mobile computing device 205 via communication link 210. Metadata including state information about the access of content can be stored on content metadata server 285. In some implementations, content storage server 275 and content metadata server 285 can co-exist on a single server or can be divided amongst multiple servers.

A device within the host location 201, such as mobile computing device 205, can act as a local content storage server and/or a local content metadata server for other devices including media processing device 235 and mobile media player 215. When a device, such as media processing device 235, cannot connect or prefers not to connect to server 275, 285, the device can connect to the mobile computing device 205 if the mobile computing device 205 is acting as a local content storage server and/or a local content metadata server.

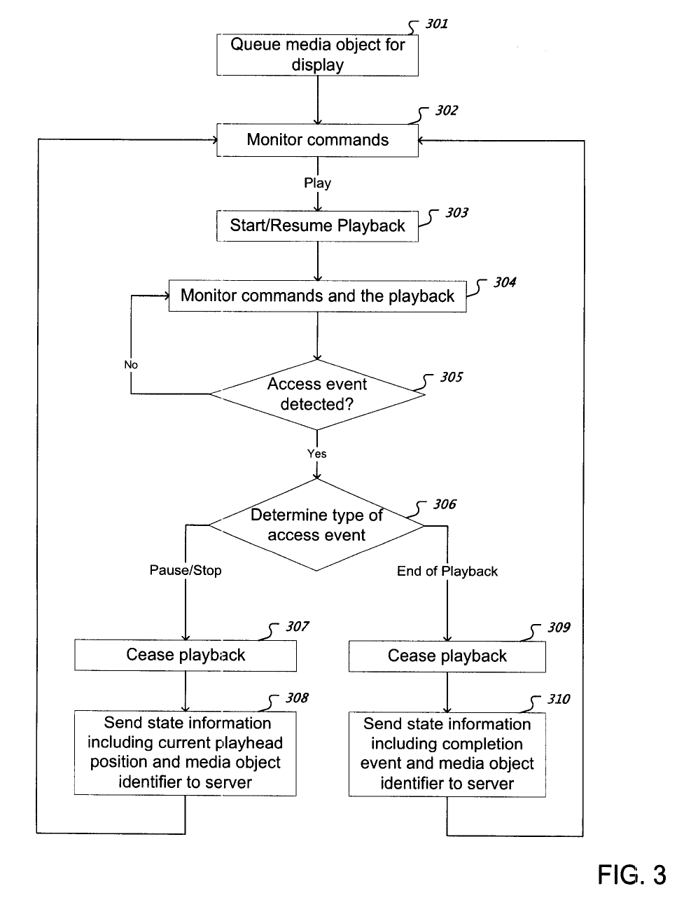

FIG. 3 shows in example of accessing content such as a media object and the accessing of the content can include playback or viewing of the media object. A content viewer running on a device such as devices 110, 135, 160 can queue 301 a media object for display. The content viewer can monitor 302 commands that include content access commands or events. When the content viewer receives a play command, the content viewer can start or resume 303 playback of the media object. The content viewer can further monitor 304 commands and the state of the playback. The content viewer can detect 305 an access event. If an access event is not detected, the content viewer can continue to monitor 304 commands and continue the playback. If an access event is detected, then the type of access event can be determined 306. If the access event includes a pause or stop command, then playback 307 can cease. State information, that can include a current playhead position on the media object and a corresponding media object identifier, can be transmitted 308 to a remote location such as a server 130. If the access event includes the end of playback of the media object, then playback 309 can cease. State information, that can include the completion of playback event and a corresponding media object identifier, can be transmitted 310 to the remote location such as a server 130.

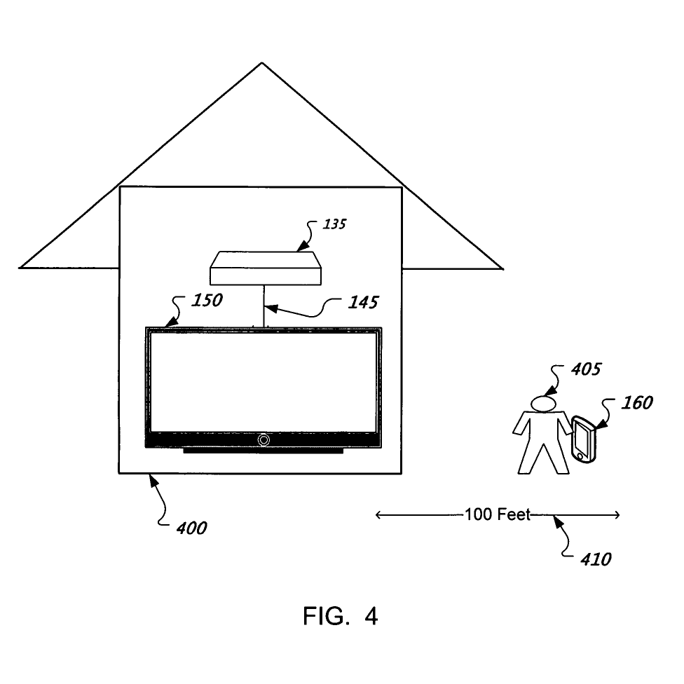

FIG. 4 shows an example of a content update event. A mobile phone 160 can be position enabled such that either the mobile phone 160 or a server can determine the distance between the mobile phone 160 and a user's home 400. When a user 405 with a mobile phone 160 comes within a user configurable range 410 from the user's home 400, a content update event can occur. In some examples, range 410 can default to 100 feet. The content update event can be sent to a server such as server 130. The media processing device 135 can listen for the content update event or server 130 can send the event to the device 135 or other devices requesting to be informed of such events. The content update event can trigger the media processing device 135 to download content and associated metadata. For example, if the user 405 is watching a media object on the mobile phone 160 when the content update event occurs, the media processing device 136 after receiving the event can download the media object so that the user 405 can continue to watch the media object on screen 150.

Another content update event can be the disconnect of a Bluetooth® wireless connection such as a connection between a mobile media device 215 and a mobile computing device 205. The shutdown process of a device 110, 135, 160 can also trigger a content update event. In some implementations, a periodic timer can be set on a device 110, 135, 160 to trigger content update events. For example, a mobile phone can be set to trigger a content update event at 8 AM. In some implementations, the content update event can be sent to a synchronization process.

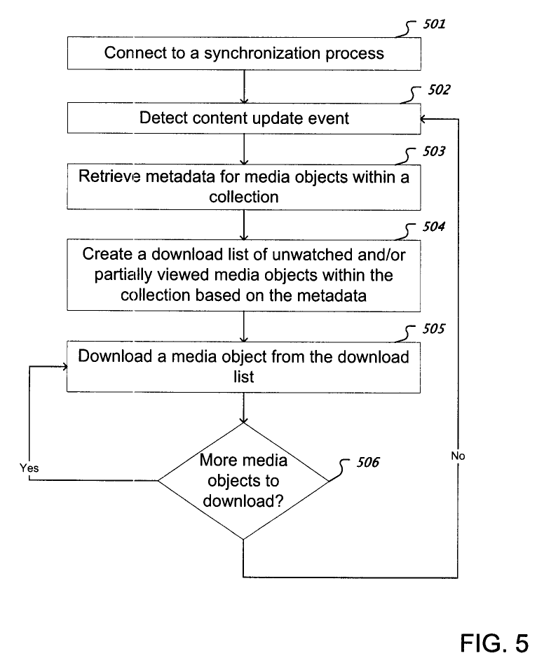

FIG. 5 shows an example of a content synchronization flowchart. A content update process running on a device 110, 135, 160 can connect 501 to a synchronization process. The synchronization process can be running at a remote location such as server 130. The content update process can detect 502 a content update event via the synchronization process. The content update process can retrieve 503 metadata for media objects within a collection. The content update process can create 504 a download list of unwatched and/or partially viewed media objects within the collection based on the metadata. The content update process can then download 505 a media object from the download list. If more media objects are to be downloaded 506, then the download 505 can continue. If no media objects remain to be downloaded, then the content update process can return to detecting 502 content update events.

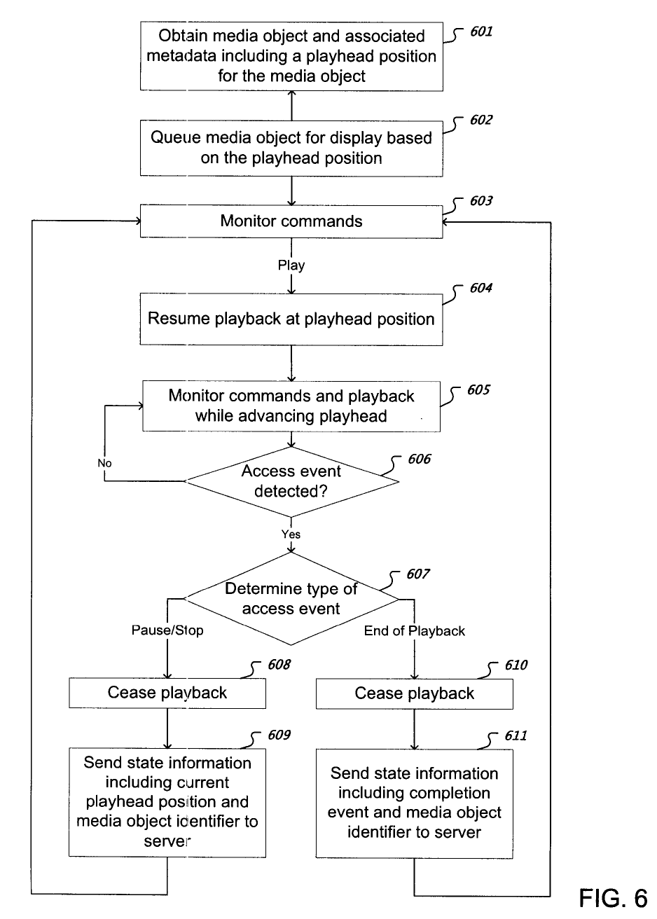

FIG. 6 shows am example of a flowchart of resuming playback based on an access state. A content viewer running on a device 110, 135, 160 can obtain 601 a media object and associated metadata including a playhead position for the media object. The media object can already be stored within a storage medium accessible by the content viewer or the media object can be downloaded in response to a content update event. The metadata associated with the media object can be already present on the device 110, 135, 160 or the metadata can be retrieved from server 130 and stored on the device 110, 135, 160. The content viewer can queue 602 media object for display based on the playhead position. In some implementations, the content viewer can queue the media object for display at a position before, at, or after the playhead position. The content viewer can monitor 603 commands. When the content viewer receives a play command, the content viewer can resume 604 playback of the media object at the playhead position. The content viewer can further monitor 605 commands and the state of the playback while advancing the playhead.

The content viewer can detect 606 an access event. If an access event is not detected, the content viewer can continue to monitor 605 commands and continue the playback. If an access event is detected, then the type of access event can be determined 607. If the access event includes a pause or stop command, then playback 608 can cease. State information, that can include a current playhead position and an identifier of the media object, can be transmitted 609 to a remote location such as a server 130. After transmitting 609, the content viewer can continue to monitor 603 monitors. If the access event includes the end of playback, then playback 610 can cease. State information, that can include the completion of playback event and an identifier of the media object, can be transmitted 611 to server 130. After transmitting 611, the content viewer can continue to monitor 603 for commands.

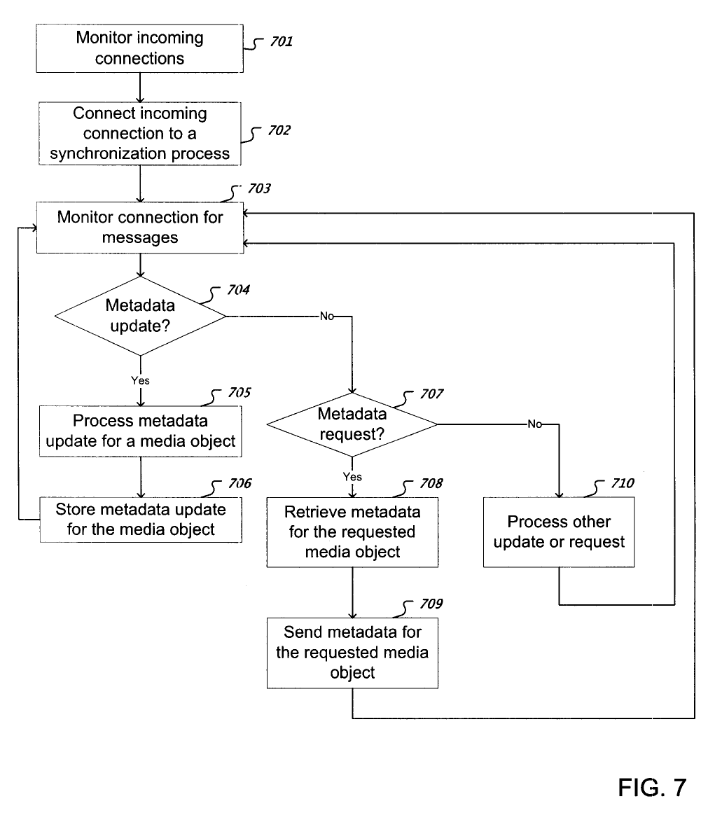

FIG. 7 shows in example of a synchronization process. The synchronization process can be running on a server such as on server 130. A server process can monitor 701 for incoming connections. The server process can connect 702 an incoming connection to a synchronization process for a user. If the synchronization process does not exist, the server process can create a synchronization process for the user. In some implementations, if a synchronization process already exists for the user, the incoming connection can use the already created synchronization process. For example, connections from multiple devices can connect to the same synchronization process. The synchronization process can monitor 703 the connection for incoming messages. The messages can be a metadata update, metadata request, or other types of updates or requests. If the message includes a metadata update 704 for a media object, then the metadata included in the message can be processed 705. The metadata can include state information about the accessing of the media object or information about the media object. State information can include a position of a playhead associated with the playback of the media object or a flag indicating that the media object has been completely accessed or viewed. The metadata update for the media object can be stored 706 on a local or remote storage device attached to the server 130 or the update can be stored in memory or a combination thereof. The synchronization process can continue to monitor 703 the connection for new messages. If the message includes a metadata request 707, then the metadata for tho requested media object can be retrieved 708. The metadata request can include a request for the state information associated with a media object. The metadata for the media object can be sent 709 over the connection. The synchronization process can continue to monitor 703 the connection for new messages. If the message contains a different type of request or update, the message can be processed 710 and the synchronization process can continue to monitor 703 the connection for new messages. For example, other messages can include content update event notifications and requests to receive such notifications. Further, other messages can include requests to receive metadata updates for a user.

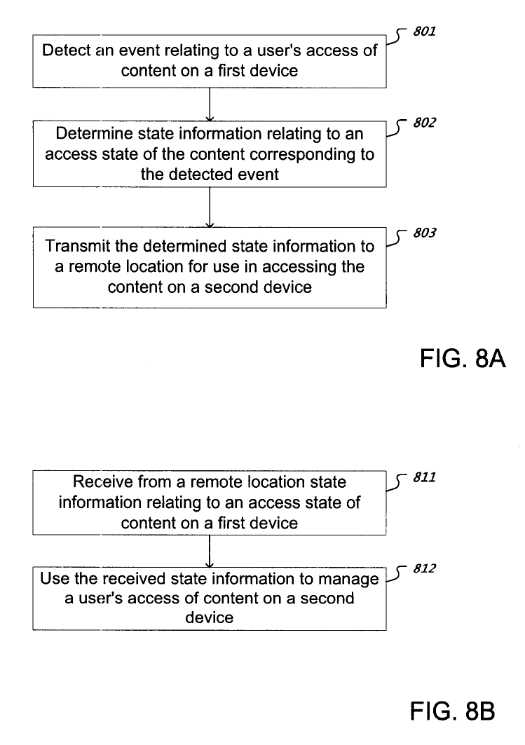

FIG. 8A shows, an example of a synchronization process from a device view point. A content viewer on a first device can detect 801 an event relating to a user's access of content on the first device. The content viewer can determine 802 state information relating to an access state of the content corresponding to the detected event. The content viewer can transmit 803 the determined state information to a remote location for use in accessing the content on a second device. The remote location can include a computer system such as a server or a personal computer. In some implementations, the remote location can include either the first or second device or both.

FIG. 8B shows an example of a synchronization process from a different device's view point. In a complementary synchronization process to that shown in FIG. 8A, a content viewer on a second device can use the state information produced on the first device. The content viewer on the second device can receive 811 from a remote location state information relating to an access state of content on a first device. The content viewer can use 812 the received state information to manage a user's access of content on a second device.

Implementations of the subject matter and the functional operations described in this specification can be implemented in digital electronic circuitry, or in computer software, firmware or hardware, including the structures disclosed in this specification and their structural equivalents, or in combinations of one or more of them. Implementations of the subject matter described in this specification can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, or a combination of one or more of them. The term “data processing apparatus” encompasses all apparatus, de,vices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform function s by operating on input data and generating output. The processes and logic flows car also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, near-touch input, or tactile input.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the subject matter. Accordingly, other implementations are within the scope of the following claims.

What is claimed is:

1. A method comprising:
detecting an event relating to a user's access of content on a first device;
determining state information relating to an access state of the content corresponding to the detected event; and
transmitting the determined state information to a remote location for use in accessing the content on a second device.

2. The method of claim 1, wherein the detected event comprises at least one of pause, stop, access complete, power off, and user input.

3. The method of claim 1, wherein the state information comprises a playhead position.

4. The method of claim 1, wherein the state information further comprises an indication of whether the content has been accessed completely.

5. The method of claim 1, wherein the content comprises video, audio, text, graphics, or a combination thereof.

6. The method of claim 1, wherein copies of the content reside on each of the first and second devices.

7. The method of claim 1, wherein the content resides at a remote location and is streamed to a device during access.

8. The method of claim 1, wherein the remote location comprises a computer system accessible via a wide area network.

9. The method of claim 1, wherein the remote location comprises a computer system within a same local area network as the first device.

10. The method of claim 1, wherein the content comprises digital video and access comprises playing a digital video file.

11. The method of claim 1, further comprising using the transmitted state information to update content residing on the second device.

12. The method of claim 1, further comprising using the transmitted state information to position an access point in the content on the second device.

13. The method of claim 1, wherein the remote location comprises a computer system within a same local area network as the second device.

14. The method of claim 1, wherein the first device is located at the remote location.

15. The method of claim 1, wherein the second device is located at the remote location.

16. The method of claim 1, wherein the content comprises one or more media objects.

17. A computer program product, encoded on a computer-readable medium, operable to cause data processing apparatus to perform operations comprising:
detecting an event relating to a user's access of content on a first device;
determining state information relating to an access state of the content corresponding to the detected event; and
transmitting the determined state information to a remote location for use in accessing the content on a second device.

18. The computer program product of claim 17, wherein the detected event comprises at least one of pause, stop, access complete, power off, and user input.

19. The computer program product of claim 17, wherein the state information comprises a playhead position.

20. The computer program product of claim 17, wherein the state information further comprises an indication of whether the content has been accessed completely.

21. The computer program product of claim 17, wherein the content comprises video, audio, text, graphics, or a combination thereof.

22. The computer program product of claim 17, wherein copies of the content reside on each of the first and second devices.

23. The computer program product of claim 17, wherein the content resides at a remote location and is streamed to a device during access.

24. The computer program product of claim 17, wherein the remote location comprises a computer system accessible via a wide area network.

25. The computer program product of claim 17, wherein the remote location comprises a computer system within a same local area network as the first device.

26. The computer program product of claim 17, wherein the content comprises digital video and access comprises playing a digital video file.

27. The computer program product of claim 17, the operations further comprising using the transmitted state information to update content residing on the second device.

28. The computer program product of claim 17, the operations further comprising using the transmitted state information to position an access point in the content on the second device.

29. The computer program product of claim 17, wherein the remote location comprises a computer system within a same local area network as the second device.

30. The computer program product of claim 17, wherein the first device is located at the remote location.

31. The computer program product of claim 17, wherein the second device is located at the remote location.

32. The computer program product of claim 17, wherein the content comprises one or more media objects.

33. A system comprising:
a processor configured to perform operations comprising:
detecting an event relating to a user's access of content on a first device;
determining state information relating to an access state of the content corresponding to the detected event; and
transmitting the determined state information to a remote location for use in accessing the content on a second device.

34. The system of claim 33, wherein the detected event comprises at least one of pause, stop, access complete power off, and user input.

35. The system of claim 33, wherein the state information comprises a playhead position.

36. The system of claim 33, wherein the state information further comprises an indication of whether the content has been accessed completely.

37. The system of claim 33, wherein the content comprises video, audio, text, graphics, or a combination thereof.

38. The system of claim 33, wherein copies of the content reside on each of the first and second devices.

39. The system of claim 33, wherein the content resides at a remote location and is streamed to a device during access.

40. The system of claim 33, wherein the remote location comprises a computer system accessible via a wide area network.

41. The system of claim 33, wherein the remote location comprises a computer system within a same local area network as the first device.

42. The system of claim 33, wherein the content comprises digital video and access comprises playing a digital video file.

43. The system of claim 33, the operations further comprising using the transmitted state information to update content residing on the second device.

44. The system of claim 33, the operations further comprising using the transmitted state information to position an access point in the content on the second device.

45. The system of claim 33, wherein the remote location comprises a computer system within a same local area network as the second device.

46. The system of claim 33, wherein the first device is located at the remote location.

47. The system of claim 33, wherein the second device is located at the remote location.

48. The system of claim 33, wherein the content comprises one or more media objects.

49. A method comprising.:
receiving from a remote location state information relating to an access state of content on a first device; and
using the received state information to manage a user's access of content on a second device.

50. The method of claim 49, wherein the state information comprises a playhead position.

51. The method of claim 49, wherein the state information further comprises an indication of whether the content has been accessed completely.

52. The method of claim 49, wherein the content comprises video, audio, text, graphics, or a combination thereof.

53. The method of claim 49, wherein the content comprises one or more media objects.

54. The method of claim 49, wherein the remote location comprises a computer system within a same local area network as the second device.

55. The method of claim 49, wherein the content comprises digital video and access comprises playing a digital video file.

56. The method of claim 49, further comprising using the transmitted state information to position an access point in the content on the second device.

57. The method of claim 49, wherein the remote location comprises a computer system within a same local area network as the second device.
